(19) United States
(12) Patent Application Publication
(10) Pub. No.: US 2005/0111330 A1
(43) Pub. Date: May 26, 2005

(54) Data reproduction apparatus and data reproduction method

(75) Inventor: Fumihiko Fukushima, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 10/990,507

(22) Filed: Nov. 18, 2004

(30) Foreign Application Priority Data
Nov. 21, 2003 (JP) P2003-391740

(51) Int. Cl. G11B 5/09

(52) U.S. Cl. 369/53.31; 369/47.32

(57) ABSTRACT

A data reproduction apparatus and method is disclosed by which, even where data cannot be reproduced correctly, data can be stored at a correct position of an ECC correction memory so that error correction of the data can be performed with certainty. A condition for permitting fetching of a sector number is set based on a detection ID by a load condition setting circuit. Where the condition is satisfied, when a load timing setting circuit detects that a frame number detected from digital data exhibits a change from a frame number within a first frame number range including a maximum frame number to another frame number within a second frame number range including a minimum frame number, a load signal is outputted from a D-type flip-flop to permit fetching (loading) of a sector number.

### BACKGROUND OF THE INVENTION

This invention relates to a data reproduction apparatus and a data reproduction method.

An optical disk has EFM (Eight to Fourteen Modulation) modulated digital data of a predetermined format recorded thereon. A data reproduction apparatus (disk reproduction apparatus) reproduces digital data recorded on the optical disk EFM and demodulates the digital data read from the optical disk by means of an optical head. Then, the data reproduction apparatus converts the demodulated digital data into digital data of a format suitable for error correction and produces address information based on information obtained from the data after the conversion. Then, the data reproduction apparatus uses the address information to store the data after the conversion into an ECC (Error Correction Code) correction memory and detects and corrects errors if the data include such errors.

The structure of data of a DVD (Digital Versatile Disc) as a representative one of optical disk on which EFM modulated digital data are recorded is described with reference to FIG. 9. Data of a DVD are formed from units of a frame, a sector and an EEC (Error Correction Code) block. One frame 100 includes a synchronizing signal part (frame synchronizing signal) 101 and a data part 102 following the synchronizing signal part 101. Such frames 100 are disposed for 13 rows each including two frames to form one physical sector 200 (26 frames).

To the synchronizing signal parts 101 of the frames of the one physical sector 200, eight different frame synchronizing codes SY0 to SY7 are allocated. It is to be noted here that a frame having the frame synchronizing code SY0 is disposed only at the top of the first row as apparently seen from FIG. 9. Accordingly, the top of the physical sector 200 can be identified by detecting the frame synchronizing code SY0. On the other hand, the frame synchronizing codes SY1 to SY4 are disposed repetitively in order at the tops of the first to thirteenth rows, and the frame SY5 is disposed prior to the data part of each of the first to fifth rows. Further, the frame synchronizing code SY6 is disposed prior to the data part of each of the sixth to ninth rows, and the frame synchronizing code SY7 is disposed prior to the data part of each of the tenth to thirteenth rows.

The frames have frame numbers 0 to 25 applied thereto in order beginning with the top of the first row thereof. Here, while the one physical sector 200 includes a plural number of frame synchronizing codes for each of the frame synchronizing codes SY1 to SY7, if the frame synchronizing codes for successive three frames are detected, then the frame number of the frame synchronizing code detected for the third time can be detected. In particular, when three different frame synchronizing codes are detected successively as seen in FIG. 10, if the frame synchronizing code detected in the present cycle is SY0 and the frame synchronizing code detected in the preceding cycle is SY7 and besides the frame synchronizing code detected in the second preceding cycle is SY4, then the frame number detected for the third time is “0. If the frame synchronizing code detected in the present cycle is SY5 and the frame synchronizing code detected in the preceding cycle is SY0 and besides the frame synchronizing code detected in the second preceding cycle is SY7, then the frame number is “1. Similarly, if the frame synchronizing code detected in the present cycle is SY7 and the frame synchronizing code detected in the preceding cycle is SY4 and besides the frame synchronizing code detected in the second preceding cycle is SY7, then the frame number detected for the third time is “25.

If the synchronizing signal parts 101 are removed from the physical sector 200 and the remaining data parts 102 are EFM (in the case of a DVD, 8/16 modulation) demodulated, then one recording sector 300 is obtained as seen in FIG. 11. To the top position of the recording sector 300, that is, to the top position of the frame number 0, an ID (Identification Data: identification code) number (hereinafter referred to as “sector ID”) is allocated. The sector ID includes one of sector numbers 0 to 15. As seen in FIG. 12, 16 recording sectors 300 of the sector numbers 0 to 15 form one ECC block 400 which makes a basic unit for error correction.

Usually, in a disk reproduction apparatus for reproducing a DVD, in order to store data of the ECC block 400 into the ECC correction memory as accurately as possible, countermeasures for protection are applied to the synchronizing signal parts 101 (frame synchronizing signals), frame synchronizing codes SY0 to SY7 and sector numbers 0 to 15. However, even if such a protection function as just described is applied, if destruction or omission of data is caused by damage to or a foreign matter sticking to the disk, then the data cannot be reproduced correctly. This disables correct reproduction of address information for storing data into the ECC correction memory. As a result, EFM demodulation data are stored at a wrong address position in the ECC correction memory, which makes error correction impossible.

In order to eliminate the trouble that address information cannot be produced correctly when data cannot be reproduced correctly by damage to or a foreign matter sticking to a disk in this manner, conventionally such a countermeasure as described below is taken. In particular, the frame synchronizing code SY0 is regarded as a sector sync and a sector ID is fetched at the timing of the frame synchronizing code SY0 and used as address information for storing EFMd demodulation data into the ECC correction memory. Consequently, the EFM demodulation data are stored in a precisely corresponding relationship to an ECC block 400 into the ECC correction memory. The apparatus just described is disclosed in Japanese Patent Laid-Open No. 2000-20334 (hereinafter referred to as Patent Document 1).

However, where the frame synchronizing code SY0 is regarded as a sector ID, if data cannot be reproduced correctly from the disk because of destruction or omission of data caused by damage to the disk or a foreign article sticking to a recording surface of the disk, a sector ID itself cannot be obtained. For example, if destruction or omission of data causes an object of data reading to jump from a frame of the frame number 24 to another frame of the frame number 1, then the frame synchronizing code SY0 itself cannot be detected, resulting in failure in detection of a sector ID. If the sector ID cannot be obtained, then address information for storing EFM demodulation data into the ECC correction memory cannot be generated. As a result, error correction is impossible, which is a subject to be solved of the apparatus of Patent Document 1. The apparatus of Patent Document 1 has a subject also in that, where the sector ID at a timing of fetching is not correct, correct address information cannot be produced.

### SUMMARY OF THE INVENTION

It is an object of the present invention to provide a data reproduction apparatus and a data reproduction method by which, even where data cannot be reproduced correctly, data can be stored at a correct position of an ECC correction memory so that error correction of the data can be performed with certainty.

In order to attain the object described above, according to an aspect of the present invention, there is provided a data reproduction apparatus wherein modulated digital data whose component unit is a sector which includes sector identification information including a sector number and a plurality of frames each of which includes a synchronizing signal, data and a frame number are demodulated and then stored into a memory and then error correction is performed for the digital data, including a first detection section for detecting a frame number from within the digital data, a second detection section for detecting sector identification information from within the digital data, an address generation section for fetching a sector number obtained from the sector identification information detected by the second detection section and generating address information for storing the digital data into the memory based on the sector number, a condition setting section for setting a condition for permitting the fetching of the sector number by the address generation section based on the sector identification information detected by the second detection section, and a permission section for discriminating whether or not the condition set by the condition setting section is satisfied and permitting, where it is discriminated that the condition is satisfied, the fetching of the sector number by the address generation section when the frame number detected by the first detection section exhibits a change from a frame number within a first frame number range which includes a maximum frame number to another frame number within a second frame number range which includes a minimum frame number.

According to another aspect of the present invention, there is provided a data reproduction method wherein modulated digital data whose component unit is a sector which includes sector identification information including a sector number and a plurality of frames each of which includes a synchronizing signal, data and a frame number are demodulated and then stored into a memory and then error correction is performed for the digital data, including a first step of detecting a frame number from within the digital data, a second step of detecting sector identification information from within the digital data, a third step of fetching a sector number obtained from the sector identification information detected at the second step and generating address information for storing the digital data into the memory based on the sector number, a fourth step of setting a condition for permitting the fetching of the sector number at the third step based on the sector identification information detected at the second step, and a fifth step of discriminating whether or not the condition set at the fourth step is satisfied and permitting, where it is discriminated that the condition is satisfied, the fetching of the sector number at the third step when the frame number detected at the first step exhibits a change from a frame number within a first frame number range which includes a maximum frame number to another frame number within a second frame number range which includes a minimum frame number.

In the data reproduction apparatus and the data reproduction method, a condition for permitting fetching of a sector number is set based on sector identification information detected from the digital data, and when the condition is satisfied, the fetching of the sector number is permitted. Consequently, the fetching of the sector number can be limited to a case only where it is estimated that the sector identification information is correct. Accordingly, address information for storing the digital data after a demodulation process into the LCC correction memory can be generated correctly Further, where the fetching of the sector number is permitted when the frame number detected from the digital data exhibits a change from a frame number within the first frame number range which includes the maximum frame number to another frame number within the second frame number range which includes the minimum frame number, a width can be provided to the fetching timing. Accordingly, even if a particular frame number misses, the fetching timing can be set with certainty.

With the data reproduction apparatus and the data reproduction method, since the fetching of the sector number is permitted when the condition set based on the sector identification information is satisfied so that the sector number is fetched only where it is estimated that the sector identification information is correct, address information for storing the digital data after the demodulation process into the ECC correction memory can be generated correctly. Consequently, the data can be stored at a correct address position. Further, since a width is provided to the fetching timing of the sector number, even if a particular frame number misses, the fetching timing can be set with certainty, and consequently, error correction can be performed with certainty.

The above and other objects, features and advantages of the present invent on will become apparent from the following description and the appended claims, taken in conjunction with the accompanying drawings in which like parts or elements denoted by like reference symbols.

### BRIEF DESCRIPTION OF THE DRAWINGS

FIG. 1 is a block diagram showing a configuration of a data reproduction apparatus to which the present invention is applied;

FIG. 2 is a timing chart illustrating a timing relationship among a sector synchronizing signal, a frame synchronizing signal, frame numbers and sector numbers;

FIG. 3 is a block diagram showing an example of a particular configuration of an ECC correction memory address generation circuit;

FIG. 4 is a diagrammatic view illustrating an example of generation of address information for an ECC correction memory;

FIG. 5 is a block diagram showing an example of a configuration of a load signal generation circuit;

FIG. 6 is a block diagram showing an example of a configuration of a load condition setting circuit;

FIGS. 7A and 7B are timing charts illustrating operation of a conventional data reproduction apparatus;

FIGS. 8A and 8B are timing charts illustrating operation of the data reproduction apparatus of FIG. 1;

FIG. 9 is a view illustrating a data structure of a DVD;

FIG. 10 is a view illustrating a relationship between frame synchronizing codes and frame numbers;

FIG. 11 is a view illustrating a configuration of one recording sector; and

FIG. 12 is a view illustrating a configuration of one ECC block.

### DETAILED DESCRIPTION OF THE PREFERRED EMBODIMENTS

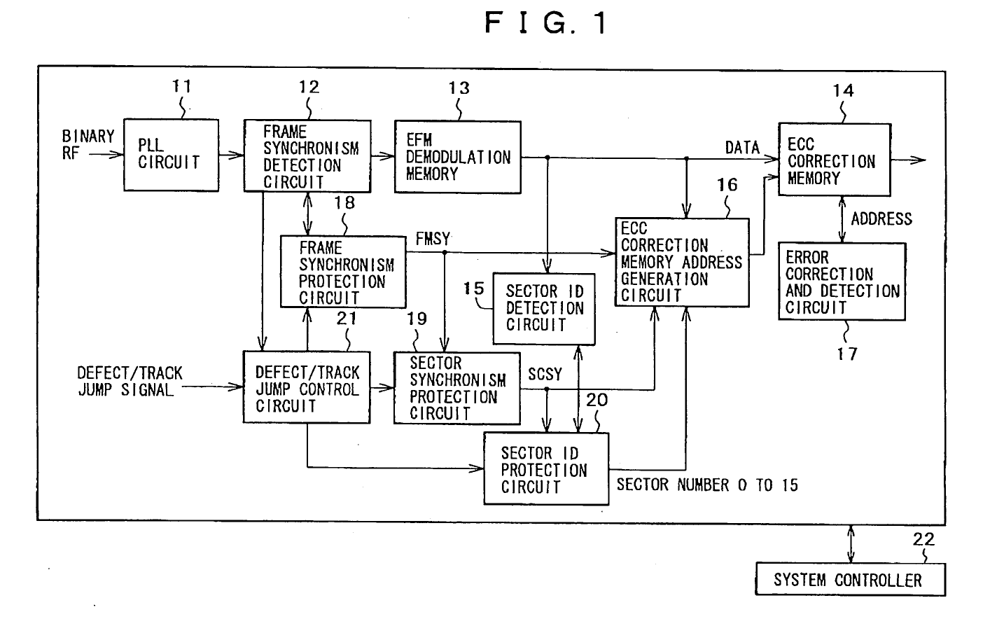

FIG. 1 shows a configuration of a data reproduction apparatus to which the present invention is applied. The data reproduction apparatus here has a system configuration for processing an RF signal obtained by reading out EFM modulated digital data recorded on an optical disk such as, for example, a DVD by means of an optical head (not shown) and then binarizing the read EFM modulated digital data.

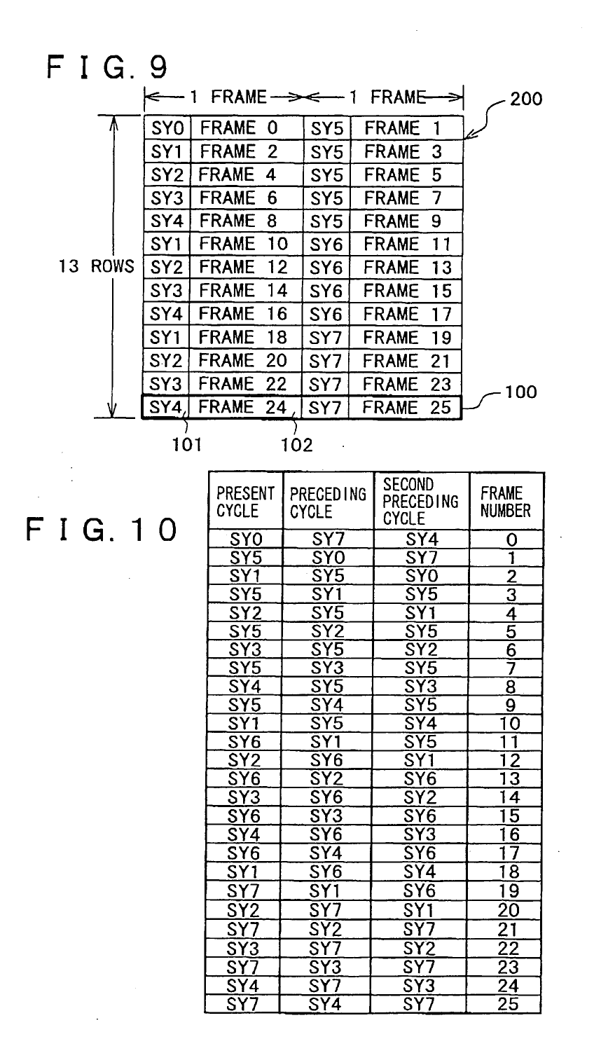

Referring to FIG. 1, an RF signal obtained by binarizing digital data read from a disk is inputted to a phase locked loop (PLL) circuit 11. The FLL circuit 11 extracts a channel clock and read data from the binary RF signal. The extracted channel clock and read data are supplied to an EFM demodulation circuit 13 through a frame synchronism detection circuit 12. The frame synchronism detection circuit 12 detects a frame synchronizing signal (synchronizing signal part 101 of FIG. 9) from the read data based on the channel clock. To the frame synchronizing signal, such frame synchronizing codes SY0 to SY7 as described hereinabove are allocated. The frame synchronism detection circuit 12 performs also a process of removing the frame synchronizing codes SY0 to SY7 from the read data of a physical sector structure (refer to FIG. 9).

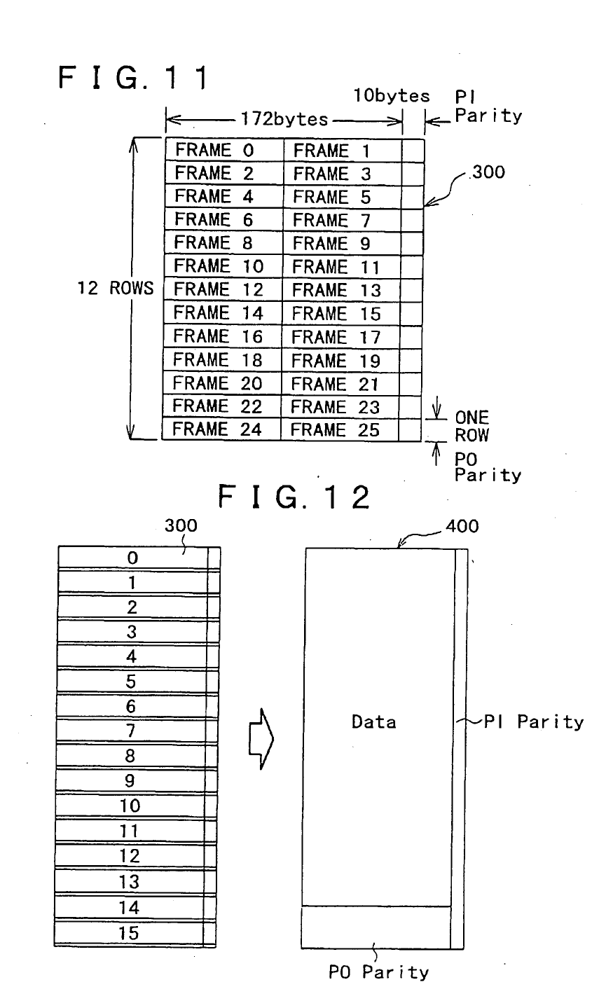

The EFM demodulation circuit 13 EFM (in the case of a DVD, 8/16 modulation) demodulates the data from which the frame synchronizing codes SY0 to SY7 have been removed. The data after the EFM demodulation (the data are hereinafter referred to as EFM demodulation data) have a recording sector structure (refer to FIG. 11) and are supplied to an ECC correction memory 14, a sector ID detection circuit 15 and an ECC correction memory address generation circuit 16. The ECC correction memory 14 stores the EFM demodulation data in a unit of an ECC block at an address position designated by address information generated by the ECC correction memory address generation circuit 16.

As described hereinabove, a sector ID (ID number) which is sector identification information is allocated to the top position of a recording sector, that is, to the top position of a frame of the frame number 0, and the sector ID detection circuit 15 which serves as a second detection section detects the sector ID. The ECC correction memory address generation circuit 16 generates address information for specifying an address position of the ECC correction memory 14 to which EFM demodulation data is to be stored. Details of a configuration and operation of the ECC correction memory address generation circuit 16 are hereinafter described. An error correction and detection circuit 17 detects whether or not EFM demodulation data stored in the ECC correction memory 14 have some errors, and corrects such errors if the errors are detected.

A frame synchronism protection circuit 18, a sector synchronism protection circuit 19 and a sector ID protection circuit 20 are protection circuits provided to store data of ECC blocks as accurately as possible into the ECC correction memory 14. More particularly, the frame synchronism protection circuit 18 protects a frame synchronizing signal FMSY detected by the frame synchronism detection circuit 12. The protected frame synchronizing signal FMSY is supplied to the ECC correction memory address generation circuit 16. The frame synchronism protection circuit 18 further has a function as a first detection section for detecting a frame number 0 to 25. The detection of a frame number 0 to 25 is performed based on a combination of frame synchronizing codes in the present, preceding and second preceding cycles when frame synchronizing codes are detected successively by three times as described hereinabove.

The sector synchronism protection circuit 19 protects a sector synchronizing signal SCSY which indicates, for example, the logic “1 (for example, a high level) over an entire frame (synchronizing signal part and data part) of the frame number 0 in a physical sector (refer to FIG. 9) which includes 26 frames of the frame numbers 0 to 25 as a unit. The protected sector synchronizing signal SCSY is supplied to the ECC correction memory address generation circuit 16. The sector ID protection circuit 20 protects a sector ID (including a sector number 0 to 15) detected by the sector ID detection circuit 15. The protected sector ID (sector number 0 to 15) is supplied to the ECC correction memory address generation circuit 16.

It is to be noted that, since correct data are not inputted in the case of defect when the optical head reads a defective portion on an optical disk such as a damaged portion or in the case of track jumping when a reading light beam emitted from the optical head crosses recording tracks, the protection operations of the frame synchronism protection circuit 18, sector synchronism protection circuit 19 and sector ID protection circuit 20 are canceled by a defect/track jump control circuit 21. In particular, when a defect/track jump signal generated from a system controller 22 upon defect or upon track jumping is received, the defect/track jump control circuit 21 cancels the protection operations of the frame synchronism protection circuit 18, sector synchronism protection circuit 19 and sector ID protection circuit 20, and then renders the operations of them effective at a point of time when a certain condition is satisfied.

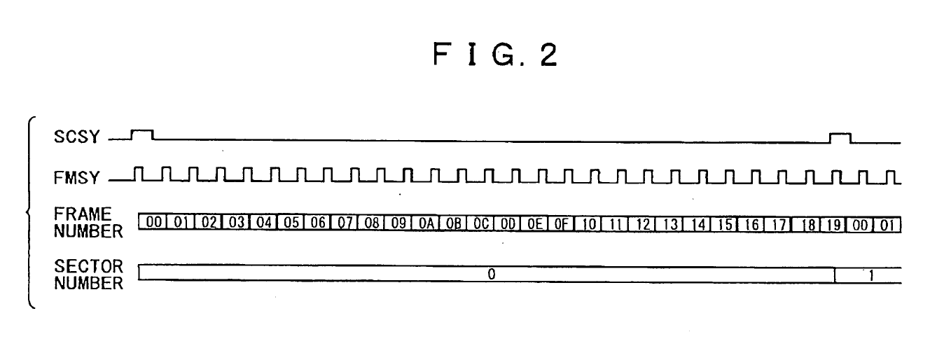

The system composed of the functional blocks described above is controlled by the system controller 22 which may be, for example, a microcomputer. FIG. 2 illustrates a timing relationship of the sector synchronizing signal SCSY, the frame synchronizing signal FMSY, frames of the frame numbers 0 to 25 and sectors of the sector numbers 0 to 15. It is to be noted that FIG. 2 illustrates the timing relationship only at the sector of the sector number 0 and a top portion of the sector of the sector number 1 for simplified illustration.

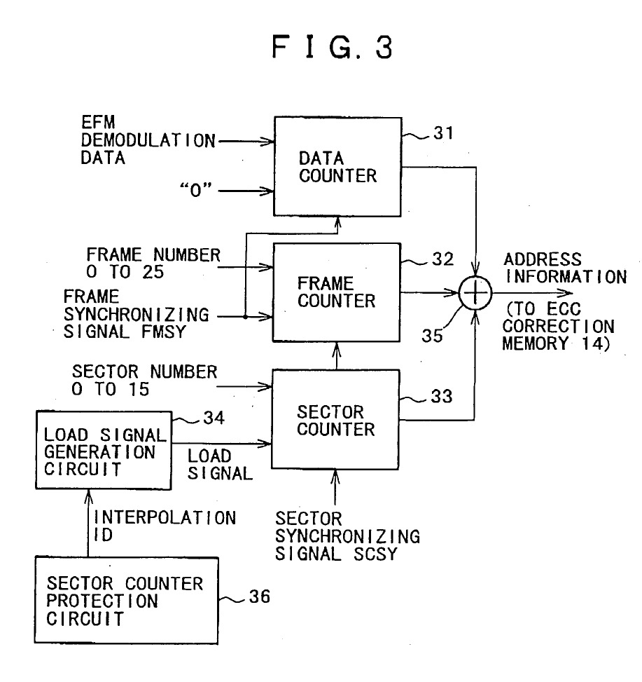

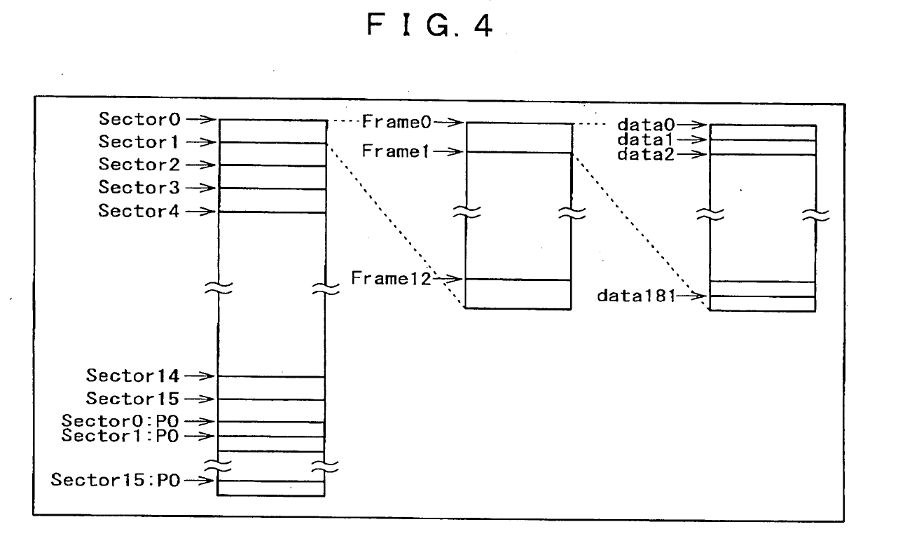

FIG. 3 shows an example of a configuration of the ECC correction memory address generation circuit 16. Referring to FIG. 3, the ECC correction memory address generation circuit 16 shown includes a data counter 31, a frame counter 32, a sector counter 33, a load signal generation circuit 34, an adder 35 and a sector counter protection circuit 36. The ECC correction memory address generation circuit 16 receives EFM demodulation data from the EFM demodulation circuit 13, the frame synchronizing signal FMSY and a frame number 0 to 25 from the frame synchronism protection circuit 18, the sector synchronizing signal SCSY from the sector synchronism protection circuit 19 and the sector ID (sector number 0 to 15) from the sector ID protection circuit 20 as inputs thereto. The ECC correction memory address generation circuit 16 generates address information which specifies an address position of the ECC correction memory 14 to which EFM demodulation data is to be stored as seen in FIG. 4.

In the ECC correction memory address generation circuit 16, the data counter 31 starts a counting operation thereof when the value “0 is loaded in synchronism with the frame synchronizing signal FMSY to count data for one frame and outputs data position (address) information as the count value thereof. The frame counter 32 is loaded with one of the frame numbers 0 to 25 in synchronism with the frame synchronizing signal FMSY and decodes and outputs the frame number 0 to 25 into and as address information, The sector counter 33 fetches, after a load signal is received from the load signal generation circuit 34, one of the sector numbers 0 to 15 in synchronism with the sector synchronizing signal SCSY (frame 0) and decodes and outputs the address number 0 to 25 into and as address information. It is to be noted that, when no load signal is supplied to the sector counter 33, that is, when a load condition A/B hereinafter described is not satisfied, the sector counter 33 increments the count value thereof in synchronism with the sector synchronizing signal SCSY.

The adder 35 adds the data position (address) information supplied thereto from the data counter 31, the address information based on the frame number 0 to 25 supplied from the frame counter 32 and the address information based on the sector number 0 to 15 supplied from the sector counter 33. Then, the adder 35 supplies a result of the addition as final address information, that is, as address information for specifying the address position when data is to be stored into the ECC correction memory 14. The sector counter protection circuit 36 generates a sector counter interpolation ID hereinafter described.

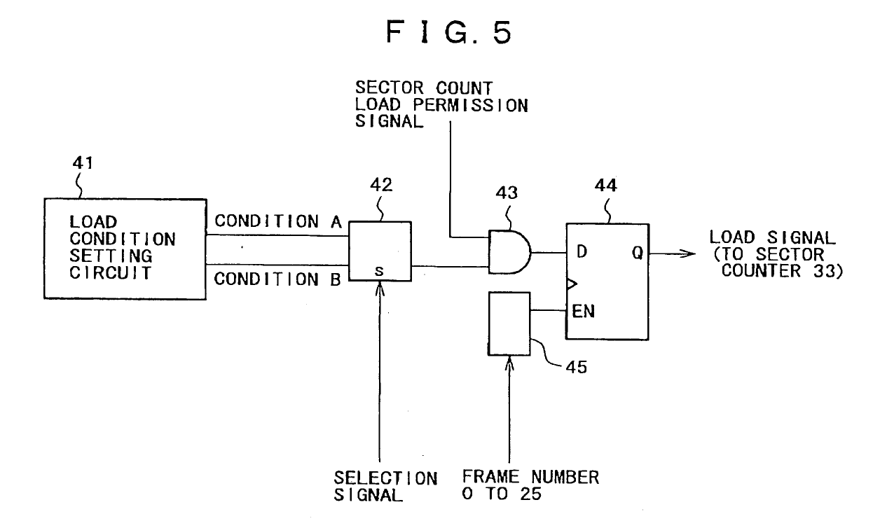

FIG. 5 shows an example of a configuration of the load signal generation circuit 34. Referring to FIG. 5, the load signal generation circuit 34 shown includes a load condition setting circuit 41, a condition selection circuit 42, an AND gate 43, a D-type flip-flop (hereinafter referred to as D-FF) 44, and a load timing setting circuit 45. The load condition setting circuit 41 sets two conditions A and B as load (fetching) conditions for a sector number 0 to 15 to the sector counter 33. A particular configuration and operation of the load condition setting circuit 41 are hereinafter described in detail.

The condition selection circuit 42 selects one of the conditions A and B set by the load condition setting circuit 41 in accordance with a selection signal supplied thereto from the system controller 22 (refer to FIG. 1). The AND gate 43 is opened when a sector count load permission signal is supplied thereto to permit the condition A/B selected by the condition selection circuit 42 to pass therethrough. The D-FF 44 receives the condition A/B having passed through the AND gate 43 as a D (data) input thereto and is placed into an enabled (EN) state in response to an output of the load timing setting circuit 45 to fetch the condition A/B. Then, a Q output of the D-FF 44 is supplied as a load signal to the sector counter 33.

The load timing setting circuit 45 supervises the frame number 0 to 25 detected by the frame synchronism protection circuit 18 and determines the timing at which the frame number changes from a frame number within a first frame number range including a maximum frame number to another frame number within a second frame number range including a minimum frame number as a load (fetching) timing of the sector number 0 to 15 into the sector counter 33. More particularly, the load timing setting circuit 45 has an output which changes to active when the frame number changes, for example, from a frame number within the first frame number range from “20 to “25 to another frame number within the second frame number range from “0 to “7, and determines the timing at which the output changes to active as a fetching (load) timing of the frame 0 to 25. The first frame number range before the chance and the second frame number range after the change may be set arbitrarily.

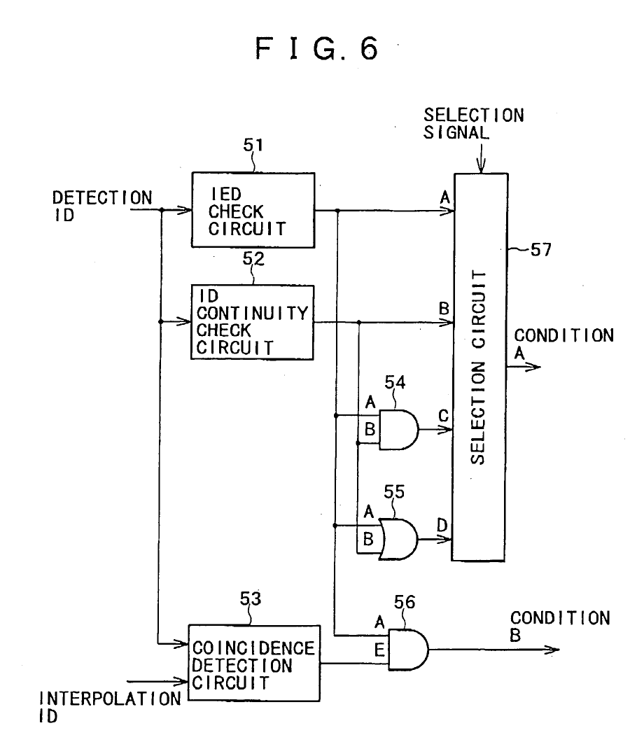

FIG. 6 shows an example of a configuration of the load condition setting circuit 41. Referring to FIG. 6, the load condition setting circuit 41 shown includes an ID error detection (IED) check circuit 51, an ID continuity check circuit 52, a coincidence detection circuit 53, an AND gate 54, an OR gate 55, another AND gate 56 and a selection circuit 57. The IED check circuit 51, ID continuity check circuit 52 and coincidence detection circuit 53 form part of the sector ID protection circuit 20 (refer to FIG. 1).

The IED check circuit 51 performs a data check according to a Reed-Solomon code of 2 bytes added to the sector ID to detect all errors of less than 2 bytes. The possibility that the IED check circuit 51 may overlook an error of 3 bytes or more is once per 30,000 times. The ID continuity check circuit 52 detects whether or not sector ID (ID numbers) are continuous. The AND gate 54 logically ANDs a detection output a of the IED check circuit 51 and a detection output b of the ID continuity check circuit 52. The OR gate 55 logically ORs the detection output a of the IED check circuit 51 and the detection output b of the ID continuity check circuit 52.

The selection circuit 57 receives the detection output a of the IED check circuit 51, the detection output b of the ID continuity check circuit 52, a logical AND output c of the AND gate 54 and a logical OR output d of the OR gate 55 as inputs thereto and selectively outputs one of the four inputs in accordance with a selection signal received from the system controller 22 (refer to FIG. 1) as a condition A. Here, one of the detection outputs a and b, logical AND output c and logical OR output d which is to make the condition A is selected in accordance with characteristics such as the reflectivity of the disk.

In particular, one of conditions 1 to 4 that the IED check result by the IED check circuit 51 is normal (OK) (condition 1), that the check result by the ID continuity check circuit 52 indicates the continuity of the sector IDs (condition 2), that any one of the conditions 1 and 2 is satisfied (condition 3) and that both of the conditions 1 and 2 are satisfied (condition 4) is selected as the condition A in accordance with the characteristics such as the reflectivity of the disk.

Here, if the result of the IED check is normal (OK), then this signifies that, although a correct sector ID is read in with a high probability, if a wrong IED check result is obtained at a load timing of the sector counter 33 (refer to FIG. 3) by chance, then correct address information cannot be generated. In order to prevent this, a sector counter interpolation ID (hereinafter referred to simply as interpolation ID) is generated and compared with the detected sector ID (hereinafter referred to as detection ID) to raise the reliability.

The comparison between the interpolation ID and the detection ID is performed by the coincidence detection circuit 53. More particularly, the coincidence detection circuit 53 discriminates whether or not the interpolation ID and the detection ID coincide with each other. The AND gate 56 logically ANDs the detection output a of the IED check circuit 51 and a detection output e of the coincidence detection circuit 53. Then, the logical AND output of the AND gate 56 makes the condition B.

The interpolation ID is generated by the sector counter protection circuit 36 (refer to FIG. 3). When the sector ID is in a locked state, that is, when the sector synchronizing signal SCSY is placed in a protected state by the sector synchronism protection circuit 19, since it is supposed that the detection ID is correct, the sector counter protection circuit 36 determines the detection ID as the interpolation ID. However, when the sector ID is in an unlocked state, that is, when the sector synchronizing signal SCSY is not placed in a protected state by the sector synchronism protection circuit 19, since it is supposed that the detection ID may not be correct, the sector counter protection circuit 36 increments the preceding detection ID value to obtain a new interpolation ID, that is, (interpolation ID+1)→interpolation ID.

In the comparison (detection of coincidence) between the interpolation ID and the detection ID, the coincidence detection circuit 53 may not perform comparison with regard to low order bits. In particular, the coincidence detection circuit 53 may compare the interpolation ID and the detection ID except at least the least significant bit like interpolation ID [23:1]=detection ID [23:1]. Where this comparison method is adopted, also in such a case that, although the detection ID is actually correct, it does not exhibit continuity because of damage to the disk or the like or as a result of a track jumping operation, a sector number 0 to 15 can be fetched. The bit width for use for comparison may be set arbitrarily.

As described hereinabove, in the data reproduction apparatus according to the present embodiment wherein digital data read from an optical disk such as, for example, a DVD are demodulated and then stored into the ECC correction memory 14 and then error correction is performed for the digital data, since a condition A/B for permitting fetching of a sector number 0 to 15 is set based on a detection ID (sector identification information) and then, when the condition A/B is satisfied, fetching (loading) of a sector number 0 to 15 into the sector counter 33 is permitted, a sector number 0 to 15 can be fetched only when it is estimated that the detection ID is correct. Accordingly, since address information for storing digital data after EFM demodulation into the ECC correction memory 14 can be generated correctly, data can be stored at a correct address position.

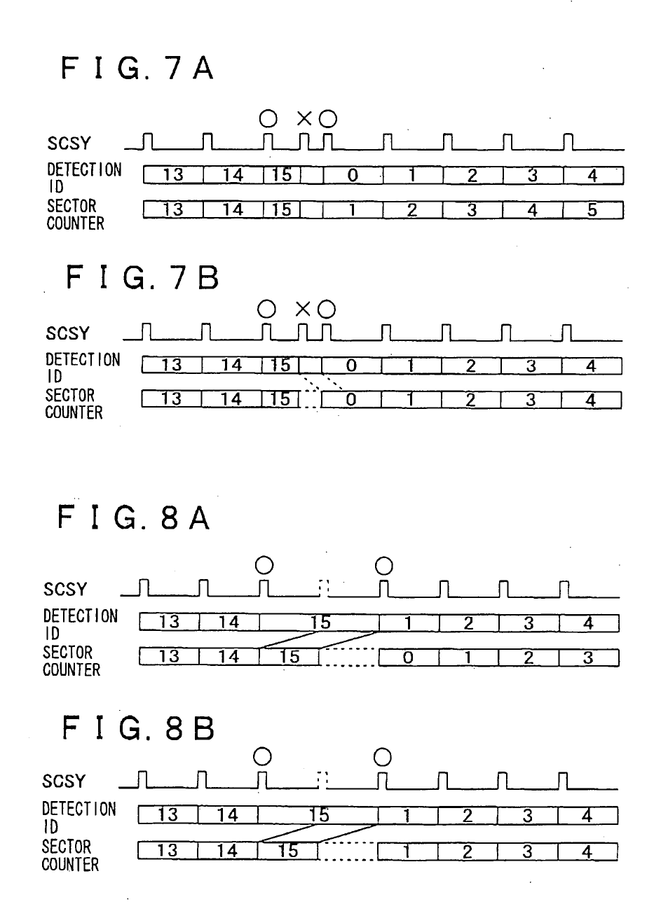

This is described in more detail in connection with a particular example. As described hereinabove with reference to FIG. 3, when a load signal is supplied from the load signal generation circuit 34, the sector counter 33 performs fetching of a sector number 0 to 15 in synchronism with the sector synchronizing signal SCSY (frame 0). Here, it is assumed that a sector synchronizing signal SCSY is generated in error, for example, between a sector of the sector number 15 and another sector of the sector number 0 as indicated by a X mark in FIGS. 7A and 7B. In this instance, in the conventional system described hereinabove wherein the sector synchronizing signal SCSY is regarded as a detection ID (refer to FIG. 7A), the sector counter 33 performs a counting (incrementing) operation in synchronism with this sector synchronizing signal SCSY generated in error. Consequently, the actual detection ID (sector number) and the count value of the sector counter 33 are placed out of coincidence with each other.

In contrast, in the apparatus of the present embodiment wherein a condition A/B for permitting fetching of a sector number 0 to 15 is set based on a detection ID (sector identification information) and then, when the condition A/B is satisfied, fetching of a sector number 0 to 15 into the sector counter 33 is permitted, if a sector synchronizing signal SCSY is generated in error as indicated by a X mark in FIG. 7E, the condition A/B is not set by the load condition setting circuit 41 and fetching of a sector number 0 to 15 into the sector counter 33 is not permitted. Consequently, the sector counter 33 does not perform a counting (incrementing) operation in synchronism with the sector synchronizing signal SCSY generated in error. Therefore, even if a sector synchronizing signal SCSY is generated in error, the actual detection ID (sector number) and the count value of the sector counter 33 coincide with each other. Accordingly, since address information for the ECC correction memory 14 can be generated correctly, data can be stored at a correct address position.

Further, in the data reproduction apparatus according to the present embodiment, when the frame number changes from a frame number within the first frame number range including the maximum frame number to another frame number within the second frame number range including the minimum frame number, particularly in the example described above, when the frame number changes from a frame number within the first frame number range of “20 to “25 to another frame number within the second frame number range of “0 to “7, fetching of a sector number 0 to 15 is permitted. Consequently, a width can be provided to the fetching timing. Accordingly, even if a situation that, because data cannot be reproduced correctly due to destruction or omission of data caused by damage to or a foreign substance sticking to the surface of the disk and, for example, the object of data reading jumps from a frame of the frame number 24 to another frame of the frame number 1, a sector synchronizing signal SCSY (frame synchronizing code SY0) cannot be detected occurs, a fetching timing of a sector number 0 to 15 into the sector counter 33 can be set with certainty. Consequently, error correction can be performed with certainty.

This is described in more detail in connection with a particular example. It is assumed here that, because the object of data reading jumps, for example, from a frame of the frame number 24 to another frame of the frame number 1 as seen in FIGS. 8A and 8B because of damage to or a foreign substance sticking to the surface of the disk, a sector synchronizing signal SCSY cannot be detected at a timing at which the sector synchronizing signal SCSY should originally be detected (indicated by a broken line in FIGS. 8A and 8B). In this instance, in the conventional system described hereinabove wherein the sector synchronizing signal SCSY is regarded as a detection ID (refer to FIG. 8A), since no sector synchronizing signal SCSY is detected, the sector counter 33 does not perform a counting (incrementing) operation. Consequently, while the detection ID indicates the sector number “1, the count value of the sector counter 33 indicates the sector number “0. Consequently, the actual detection ID (sector number) and the count value of the sector counter 33 are placed out of coincidence with each other.

In contrast, in the data reproduction apparatus according to the present invention (refer to FIG. 8B), even if the object of data reading jumps, for example, from a frame of the frame number 24 to another frame of the frame number 1 because of damage to or a foreign substance sticking to the surface of the disk, since the change of the frame number from a frame number within the first frame number range of “20 to “25 to another frame number within the second frame number range of “0 to “7 is detected by the load timing setting circuit 45 (refer to FIG. 5), fetching of a sector number 0 to 15 is permitted Consequently, a counting operation of the sector counter 33 is performed. Therefore, the actual detection ID (sector number) and the count value of the sector counter 33 are placed into coincidence with each other. Accordingly, since address information for the ECC correction memory 14 can be generated correctly, data can be stored at a correct address position.

It is to be noted that, while, in the embodiment described above, read data of a DVD are demodulated first and then stored into the error correction memory and then error correction is performed for the data, the present invention is not applied restrictively to reproduction of read data of a DVD. In other words, the present invention can be applied to the whole data reproduction wherein modulated digital data composed of blocks each including a plurality of sectors each of which includes sector identification information including a sector number and a plurality of frames each of which includes a synchronizing signal part and a data part are demodulated and then stored into a memory and then error correction is performed for the digital data.

While a preferred embodiment of the present invention has been described using specific terms, such description is for illustrative purposes only, and it is to be understood that changes and variations may be made without departing from the spirit or scope of the following claims.

1. A data reproduction apparatus wherein modulated digital data whose component unit is a sector which comprises sector identification information comprising a sector number and a plurality of frames each of which comprises a synchronizing signal, data and a frame number are demodulated and then stored into a memory and then error correction is performed for the digital data, comprising:
a first detection section for detecting a frame number from within the digital data;
a second detection section for detecting sector identification information from within the digital data;
an address generation section for fetching a sector number obtained from the sector identification information detected by said second detection section and generating address information for storing the digital data into said memory based on the sector number;
a condition setting section for setting a condition for permitting the fetching of the sector number by said address generation section based on the sector identification information detected by said second detection section; and
a permission section for discriminating whether or not the condition set by said condition setting section is satisfied and permitting, where it is discriminated that the condition is satisfied, the fetching of the sector number by said address generation section when the frame number detected by said first detection section exhibits a change from a frame number within a first frame number range which comprises a maximum frame number to another frame number within a second frame number range which comprises a minimum frame number.

2. A data reproduction apparatus according to claim 1, wherein said condition setting section comprises:
a first checking section for checking a data error of the sector identification information detected by said second detection section; and
a second checking section for checking the continuity of the sector identification information detected by said second detection section, and sets the condition based on results of the checking by said first and second checking means.

3. A data reproduction apparatus according to claim 2, wherein said condition setting section selectively sets, as the condition, one of a first condition that the checking result by said first checking result by said second checking section indicates the continuity of the sector identification information, a third condition that any one of the first and second conditions is satisfied, and a fourth condition that both of the first and second conditions are satisfied.

4. A data reproduction apparatus according to claim 3, wherein said condition setting section further comprises:
a protection section for determining, when it is supposed that the sector identification information detected by said second detection section is correct, the sector identification information as interpolation sector identification information but incrementing, when it is supposed that the sector identification information detected by said second detection section is not correct, the latest interpolation sector identification information to produce new interpolation sector identification information; and
a coincidence detection section for detecting coincidence between the sector identification information detected by said second detection section and the interpolation sector identification information generated by said protection section, and sets, as the condition, a fifth condition that said coincidence detection section detects coincidence or one of the first to fourth conditions.

5. A data reproduction apparatus according to claim 1, wherein said condition setting section further comprises:
a protection section for determining, when it is supposed that the sector identification information detected by said second detection section is correct, the sector identification information as interpolation sector identification information but incrementing, when it is supposed that the sector identification information detected by said second detection section is not correct, the latest interpolation sector identification information to produce new interpolation sector identification information; and
a coincidence detection section for detecting coincidence between the sector identification information detected by said second detection section and the interpolation sector identification information generated by said protection section, and sets, as the condition, a condition that said coincidence detection section detects coincidence.

6. A data reproduction apparatus according to performs the coincidence detection between the sector identification information and the interpolation sector identification information except a low order bit or bits.

7. A data reproduction apparatus according to claim 1, wherein said permission section can arbitrarily set the first and second frame number ranges.

8. A data reproduction method wherein modulated digital data whose component unit is a sector which comprises sector identification information comprising a sector number and a plurality of frames each of which comprises a synchronizing signal, data and a frame number are demodulated and then stored into a memory and then error correction is performed for the digital data, comprising:
a first step of detecting a frame number from within the digital data;
a second step of detecting sector identification information from within the digital data;
a third step of fetching a sector number obtained from the sector identification information detected at the second step and generating address information for storing the digital data into said memory based on the sector number;
a fourth step of setting a condition for permitting the fetching of the sector number at the third step based on the sector identification information detected at the second step; and
a fifth step of discriminating whether or not the condition set at the fourth step is satisfied and permitting, where it is discriminated that the condition is satisfied, the fetching of the sector number at the third step when the frame number detected at the first step exhibits a change from a frame number within a first frame number range which comprises a maximum frame number to another frame number within a second frame number range which comprises a minimum frame number.

9. A data reproduction method according to claim 8, wherein, at the fourth step, a data error of the sector identification information detected at the second step is checked and the continuity of the sector identification information detected at the second step is checked, and the condition is set based on results of the checking of a data error and the checking of the continuity.

10. A data reproduction method according to claim 9, wherein, at the fourth step, one of a first condition that the checking result of a data error is normal, a second condition that the checking result of the continuity indicates the continuity, a third condition that any one of the first and second conditions is satisfied, and a fourth condition that both of the first and second conditions are satisfied, is selectively set as the condition.

11. A data reproduction method according to claim 10, wherein, at the fourth step, when it is supposed that the sector identification information detected at the second step is correct, the sector identification information is determined as interpolation sector identification information but, when it is supposed that the sector identification information detected at the second step is not correct, the latest interpolation sector identification information is incremented to produce new interpolation sector identification information, and a fifth condition that the sector identification information detected at the second step and the interpolation sector identification information coincides with each other or one of the first to fourth conditions is determined as the condition.

12. A data reproduction method according to claim 8, wherein, at the fourth step, when it is supposed that the sector identification information detected at the second step is correct, the sector identification information is determined as interpolation sector identification information but, when it is supposed that the sector identification information detected at the second step is not correct, the latest interpolation sector identification information is incremented to produce new interpolation sector identification information, and a condition that the sector identification information detected at the second step and the interpolation sector identification information coincides with each other is set as the condition.

13. A data reproduction method according to claim 12, wherein the coincidence detection between the sector identification information and the interpolation sector identification information at the fourth step is performed except a low order bit or bits.

14. A data reproduction method according to claim 8, wherein the first and second frame number ranges can be set arbitrarily.
